(19) United States
(12) Patent Application Publication
(10) Pub. No.: US 2015/0324807 A1
(43) Pub. Date: Nov. 12, 2015

(54) CARBON EMISSIONS CREDITS SYSTEM

(71) Applicant: Christopher N. Pacheco, Mystic, CT (US)

(72) Inventor: Christopher N. Pacheco, Mystic, CT (US)

(21) Appl. No.: 14/708,902

(22) Filed: May 11, 2015

Related U.S. Application Data
(60) Provisional application No. 61/990,869, filed on May 9, 2014.

(51) Int. Cl. G06Q 30/00

(52) U.S. Cl. CPC G06Q 30/018

(57) ABSTRACT

A method of tracking and transferring carbon emissions credits for qualifying vehicles, including zero emissions vehicles and partial zero emissions vehicles, comprises registering the qualifying vehicle with a verification database; logging distance traveled over a time period of the qualifying vehicle, the qualifying vehicle having a carbon emissions rate; recording the distance traveled over the time period in a verification database; calculating a carbon emissions credit based on the distance traveled, time period and the carbon emissions rate; and transferring the carbon emissions credit to a third party, optionally through a carbon emissions credit exchange, where the qualifying vehicle owner/operator receives a rebate or payment in exchange for unused carbon emissions credits. The rebate or payment optionally being applied to a purchase price, future maintenance or vehicle inspection services for the qualifying vehicle.

### CROSS-REFERENCE TO RELATED APPLICATION

This patent document claims priority to earlier filed U.S. Provisional Patent Application No. 61/990,869, filed May 9, 2014, the entire contents of which are incorporated herein by reference.

### BACKGROUND

1. Technical Field

The present patent document relates generally to carbon emissions credit systems and more particularly methods of efficiently exchanging carbon emissions credits between parties.

2. Background of the Related Art

Today and for the last 10 years, companies have been buying and selling CO₂ emissions “credits” as “offsets” for projects, new developments, green advertising, sustainability commitments and to comply with local and federal laws both within the United States and abroad that limit CO₂ emissions. With respect to legislation, both state and local governments have limits on the CO₂ emitted to the atmosphere by industry (e.g. power companies, refineries). If companies exceed the CO₂ emissions limits they can either pay a fee to the state or federal government or have the opportunity to purchase CO₂ credits from other companies that are below their limits or through other CO₂ emissions venues to offset the excess CO₂ emissions. Currently companies are purchasing CO₂ emissions credits as “offsets” generated through various means some of which include significant land or forestry purchases by which the purchasing company commits to maintaining the forestry as well as several biomass projects currently underway in states such as California (CO₂ is retained within the trees and soil thus not being released into the air). With these existing and other CO₂ credit systems in development and further legislation to limit CO₂ emissions, there exists a need for additional CO₂ emissions systems to create additional “credits” available for trading. Of note, while the legislation is intended to reduce the overall generation and release of CO₂ into the atmosphere, it can be cost prohibitive for some companies to redesign and reengineer their CO₂ generation and emission systems to meet the new federal CO₂ emissions requirements and as a result choose to purchase the CO₂ “credits” on the exchange. Another advancement in CO₂ emissions reduction is via automakers in the state of California that are required to produce a certain percentage of Zero Emissions Vehicles (“ZEVs”) or Partial Zero Emissions Vehicles (“PZEVs”) each year or pay a penalty to the government. Companies that do not meet these ZEV production requirements then purchase credits from other automakers on the CO₂ exchange (e.g. there is one particular automaker that sells ZEV credits for each vehicle manufactured). So there exists a future in the further development, demand and production for ZEVs and PZEV and as a result a future for ZEVs and PZEVs to provide a source for CO₂ Emissions credits or “offsets” available to industry.

CO₂ emissions credits for the operation or use of ZEVs, PZEVs and other non-emissions generating vehicles create untapped value to industry and a return to the investors or owners of the ZEV/PZEV as pioneers in the use of this technology. Presently, there are a number of opportunities for companies to purchase and sell emissions credits through “registries”, which are essential for issuing, holding and transferring carbon credits. However, as previously mentioned they are typically reserved for projects and relatively large/significant transactions.

Therefore, there is a perceived need in the industry for a more efficient method of transfer of emissions credits between parties best able to utilize the credits and/or maximize the credits social utility.

### SUMMARY

The present invention solves the problems of the prior art by providing a system that provides for tracking and transferring emissions credits for ZEV/PZEVs, which can then be sold on the open market.

In this system, consumers as operators/owners/drivers of ZEV/PZEVs submit “logged/recorded” miles per day, week, month, etc. into a recording system and verification database. While the legitimate CO₂ emissions value of one driver is relatively small when compared to other sources that are currently traded on the exchange through the current “registries,” the collective sum of multiple operators logging and submitting their miles has the potential to create substantial credits available for trading and as a result value to both sellers and consumers when traded as carbon credits in the form of offsets.

Once a sufficient number of “available and legitimate” carbon credits are generated, they could be presented to the carbon exchange and sold to those desiring to reduce their CO₂ footprint and ultimately returning value to the individual operators/owners/drivers of the ZEV/PZEVs. Clearly once registered, these credits would be consumed and unavailable for additional “credit” or trading.

Some typical numbers: The typical vehicle in 2010 had a fuel economy of 21.5 miles per gallon and the average commuter vehicle in that same year traveled 11,493 miles resulting in an approximate CO₂ emission of ˜5 metric tons/vehicle/year. In terms of value, one ton of CO₂ in 2008 was $36 US dollars and in 2012 was $12 US dollars. Since ZEV drivers generate zero emissions, when compared to the average vehicle, using the 5 tons of CO₂/year estimate and the low end 2012 value per ton of $12 US dollars, the average ZEV driver generates a total average CO₂ value on the CO₂ exchange of ˜$60 US dollars. Using the 2008 figures the total average CO₂ value on the CO₂ exchange approaches ˜$180 US dollars. As mentioned earlier there is very little value on the exchange from one user trading CO₂ credits on an annual basis. When multiple operators/owners submit their legitimate miles driven compared to the annual average automobile, the potential value on the carbon exchange is significant. These emissions credits would then be tracked/logged/managed in a verification system to ensure single use legitimacy prohibiting excessive credits.

The system includes an internet web-portal where owners register their vehicles, record or log their legitimate miles. Once sufficient credits are accumulated and a demand exists for the CO₂ emissions credits, the emissions credits would be traded/sold on the exchange and the value less expenses for the trade would be returned to the ZEV/PZEV owners registered in the system or something similar. An emissions database for these vehicles would manage the commitments and verification of the CO₂ emissions.

Current estimates for 2013 put more than 150,000 plug-in ZEV/PZEVs on the roads in the United States. A futures estimate puts more than 7.8 million ZEV/PZEVs (4.4 ZEVs and 3.4 PZEVs) on the road in the United States alone by 2020. There are over 15 different models of ZEV/PZEVs available in 2013 for consumers to purchase and register as potential participants to the proposed ZEV/PZEV carbon tracking, accumulating and credit exchange in this opportunity.

### BRIEF DESCRIPTION OF THE DRAWINGS

These and other features, aspects, and advantages of the present invention will become better understood with reference to the following description, appended claims, and accompanying drawings where:

FIG. 1 a flowchart is shown illustrating the steps of a dealer offering a customer a rebate from a third party supplier;

FIG. 2 a flowchart is shown illustrating the steps of a purchaser/owner of a ZEV/PZEV learning of an opportunity to sell emissions credits;

FIG. 3 a flowchart is shown illustrating the steps of making discount offerings at the time of vehicle inspection;

FIG. 4 a flowchart is shown illustrating the steps of a lessee of a ZEV/PZEV learning of opportunities for emissions credits; and

FIG. 5 a flowchart is shown illustrating the steps of a corporation acquiring corporation emissions credits for ZEV/PZEV fleet.

### DESCRIPTION OF THE PREFERRED EMBODIMENT

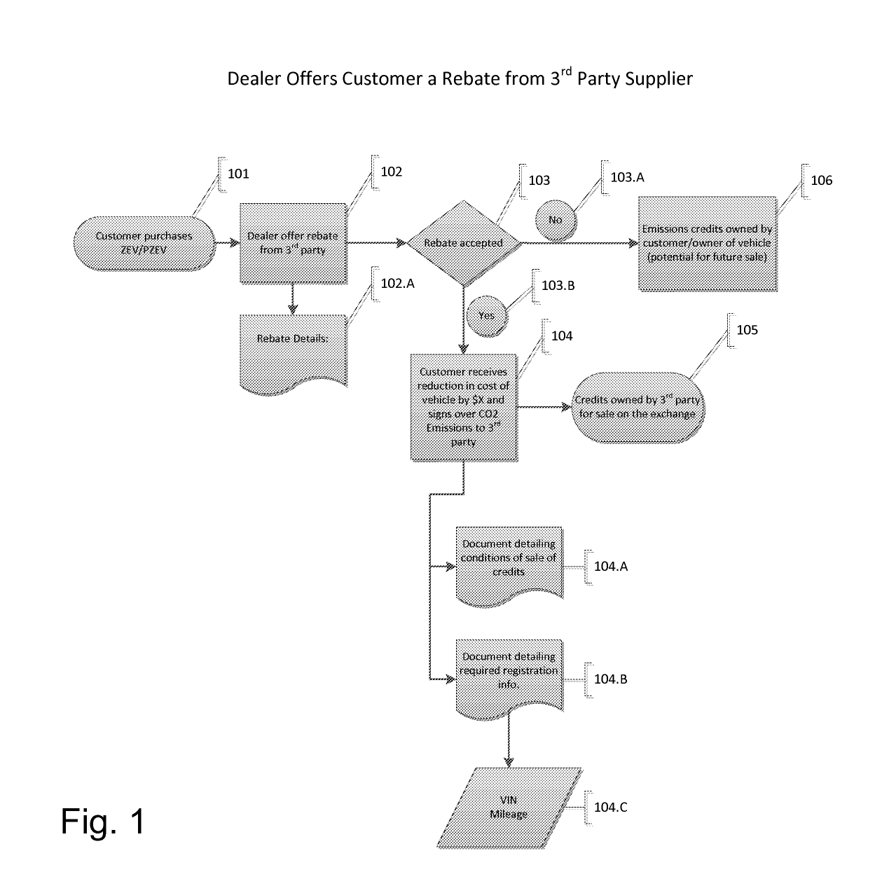

Referring now to FIGS. 1-5, the carbon emissions credit system is shown generally. There are several scenarios where the transfer of credits may occur. Each of the FIGS. 1-5 details a different scenario where the emission credits may be offered, transferred or otherwise subject to a transaction thereby maximizing the utility of the credit and benefit to the environment.

As mentioned above, in this system, consumers as operators/owners/drivers of ZEV/PZEVs submit “logged/recorded” miles per day, week, month, etc. into a recording system and verification database. It should be understood that the system may be employed in any type of operating system. The system may be implemented in any type of software code using any language and can run on any type of computer hardware or networked computer hardware, including virtual machines. The computer hardware, virtual or physical, generally includes a processor, a program memory, and a data storage. The computer hardware may be networked, wired and wirelessly, to other computer hardware and accessible via other electronic devices, such as smartphones, PDAs and the like. Furthermore, the vehicles themselves, through an onboard computer, OEM or aftermarket, may self-report to the system, wirelessly or via a code reader at a garage, dealership and/or service station.

In a first scenario illustrated in FIG. 1, the dealer offers a customer a rebate from third party supplier. In a step 101, the customer purchases Zero Emissions Vehicle (ZEV) or Partial Zero Emissions Vehicle (PZEV). In a step 102, the dealer offers the customer a rebate on the purchase of the vehicle from the third party. The third party is purchasing the emissions credits for the life of the vehicle (˜8 years) and in turn supplying the customer with a reduction in costs associated with either the purchase price of the vehicle or ongoing routine dealer supplied maintenance (e.g. a $20 reduction in annual maintenance of the vehicle). In a step 102, a document containing the details of the contract (e.g. VIN supplied with annual mileage of the vehicle/mileage of each maintenance/service event provided by the dealership) is presented to the customer in a step 102.A, where, in a step 103, the customer is faced with the decision of accepting 103.B or declining 103.A the rebate.

In a step 104, a customer commits to the sharing and reporting of the VIN and associated miles reporting requirements in order to receive reductions in the annual cost of maintenance. The customer is provided a document 104.A that details providing reporting information and legal details and conditions of sale of emissions. The customer is also provided a document 104.B that details required registration information. The customer must periodically provide data to support emissions claims such as VIN and mileage 104c. The provided data must be verified to ensure legitimate emissions credit available (e.g. through an EMDbase).

Upon acceptance of the contract terms 103.B, the emissions credits are transferred and owned by the third party in another step 105. If the customer declines sale of the emissions credits, the customer retains the rights to the emissions credits from the vehicle and potential for future sale of emissions credits (consider registering online in the future) at step 106.

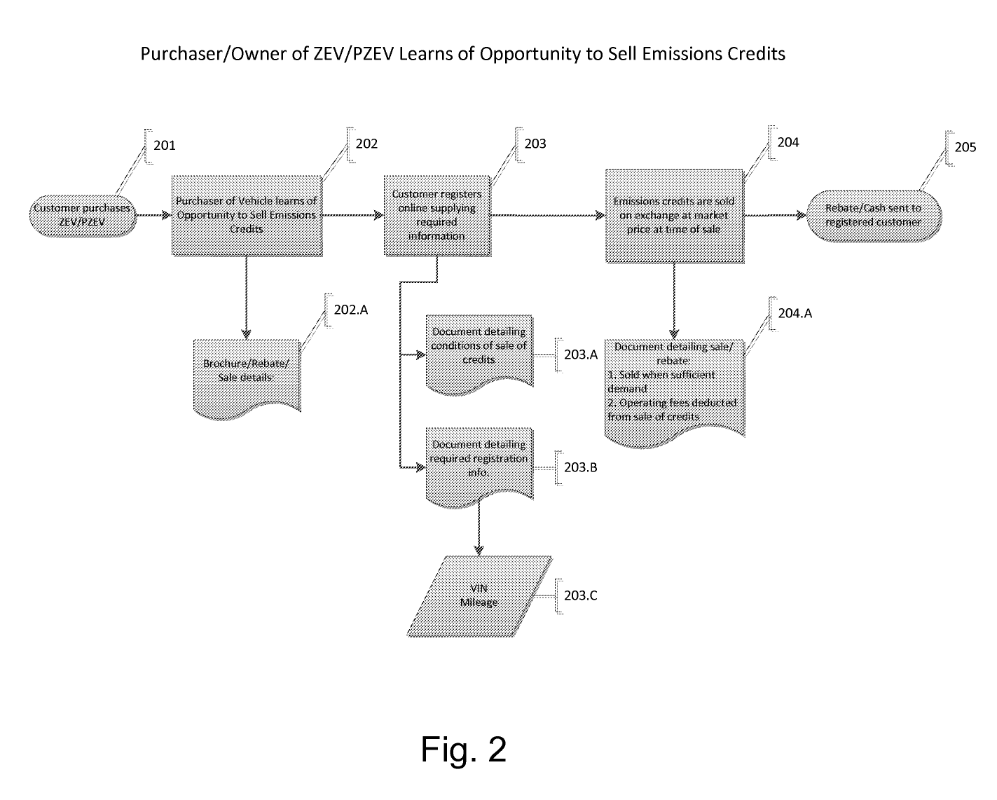

In another scenario illustrated in FIG. 2, a purchaser/owner of a ZEV/PZEV learns of opportunity to sell emissions credits at step 200. In this scenario, the customer purchases ZEV/PZEV at step 201. The owner of vehicle learns of opportunity to commit and sell emissions credits to a third party at step 202. A document containing details of the emissions credits exchange is presented to the owner at step 202.A. Like the process described previously in FIG. 1, the customer registers online providing required information for emissions sales including sharing and reporting of the VIN and associated miles reporting requirements in order to receive emissions credits reimbursement at step 203. This step 203.A includes providing the customer with a document that details the conditions of providing reporting information and legal details and conditions of sale of emissions. The customer must also provide a document detailing required registration information at step 203.B and agree to periodically provide data to support emissions claims such as VIN and mileage at step 203.C. Data must be verified at appropriate periodicity to ensure legitimate emissions (e.g. through an EMDbase)

At step 204, the emissions credits are sold by third party at market price for reimbursement to registered owners. The document containing details of reimbursement to owners of ZEV and PZEV is provided to the owner at step 204.A. A cash/reimbursement is then sent to registered online owner of ZEV/PZEV at step 205.

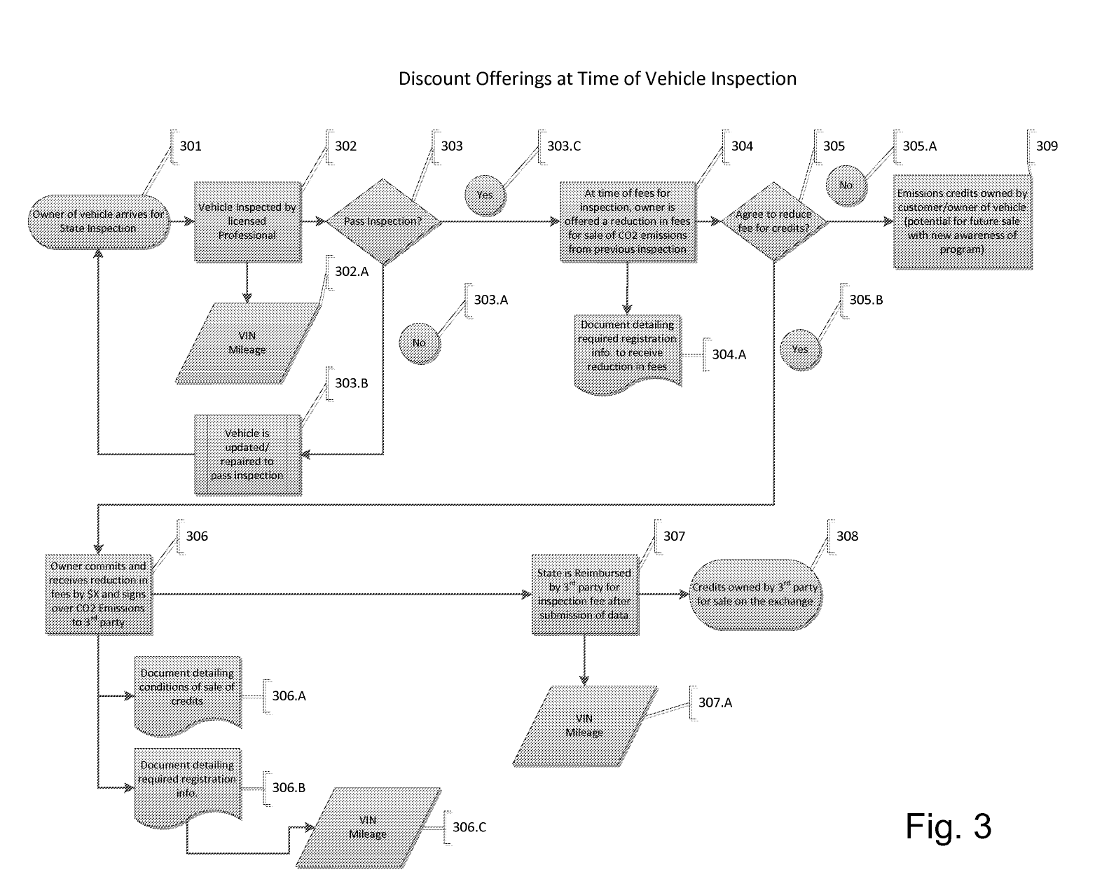

In a third scenario illustrate in FIG. 3, a discount offering is made at the time of the vehicle inspection. In step 301, the owner of the vehicle brings the ZEV or PZEV to an inspection station. At step 302, the vehicle is inspected by licensed/registered professional. At step 302.A, data is collected by the professional and includes VIN, odometer readings for eligible mileage. At step 303, the professional determines if the vehicle passes inspection. If the vehicle does not pass at step 303.A, the vehicle is updated to meet requirements to pass inspection at step 303.B.

If the vehicle passes inspection at step 303.C, and at the time of fees for inspection are due at step 304, the vehicle owner is offered reduction in inspection fees for the sale of any eligible emissions credits available since the original or last inspection. A document detailing required information VIN and associated miles to receive reduction in fees provided credits for emissions have not been previously committed is presented to the owner at step 304.A. They will be verified by third party (e.g. through EMDbase).

At step 305, the owner must decide to accept or decline the offer of the reduced inspection fee for the sale of CO₂ emissions credits. At step 305.A, if the owner declines the offer, the owner of ZEV/PZEV retains the rights to the emissions credits from the vehicle and potential for future sale of emissions credits (consider registering online in the future) at step 309.

At step 305.B, if the owner chooses to accept the offer, the owner of ZEV/PZEV commits providing required information to receive reduction in inspection and signs over emissions credits to third party at step 306, provided credits for emissions have not been previously committed. At step 306.A, a document detailing the contract is provided to the owner which details required reporting information and legal details and conditions of sale of emissions. The owner is also presented with a document detailing required registration information at step 304.B and must agree to provide data to support emissions claims such as VIN and mileage at step 304.C. Data must be verified to ensure legitimate emissions (e.g. through an EMDbase)

At step 307, the State authority for registering vehicles is reimbursed by the third party for inspection credit/fee reduction after submission of the data, which includes VIN, odometer readings for eligible mileage, noted in step 307.A. At step 308, the emissions credits are transferred and owned by the third party for retention/sale on exchange. Data must be verified at appropriate periodicity to ensure legitimate emissions (e.g. through an EMDbase)

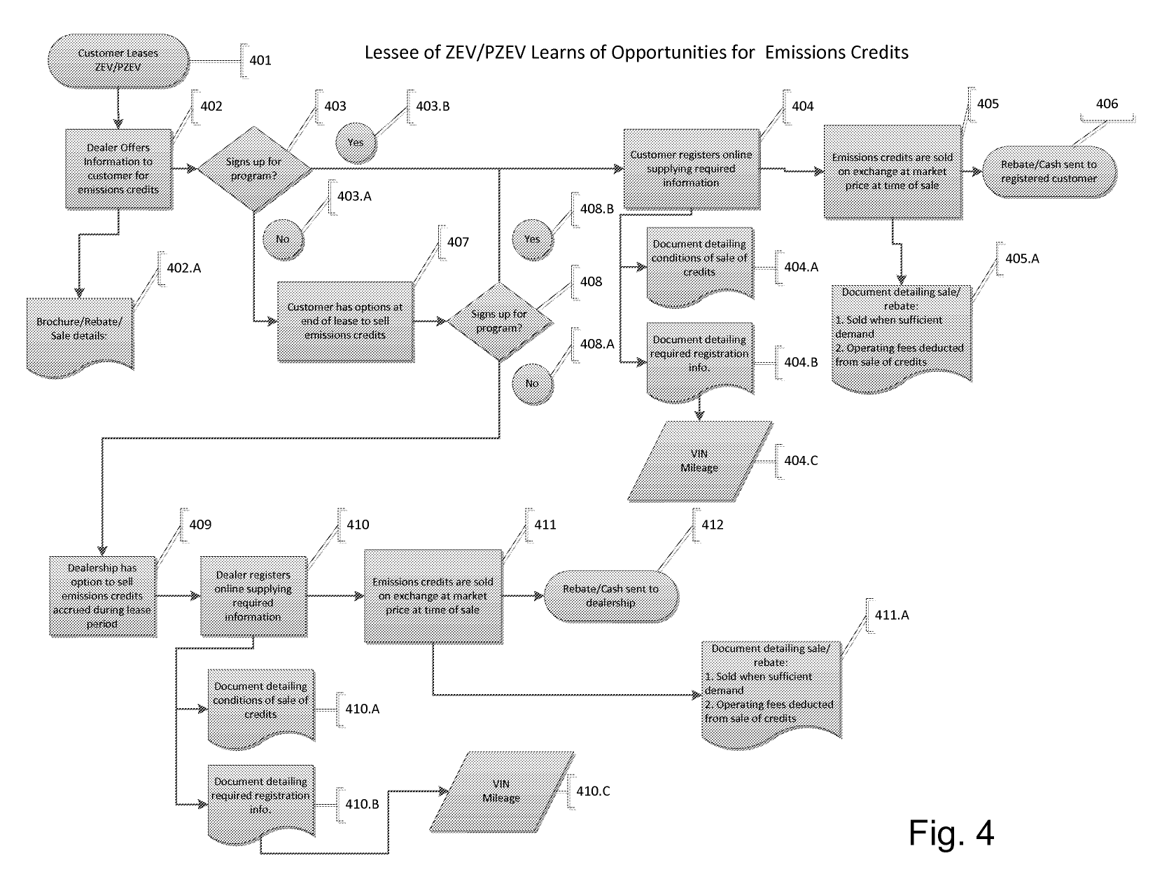

In a fourth scenario illustrated in FIG. 4, a lessee of ZEV/PZEV Learns of opportunities for emissions credits. In a step 401, the customer leases ZEV or PZEV. In a step 402, the dealer offers information to the customer/lessee for emissions credits. The offer includes a document 402.A containing details of the emissions credits exchange. In a step 403, the customer must decide to decline 403.A. or accept 403.B the offer.

If the customer accepts 403B, in a next step 404, the customer registers online providing required information for emissions sales including sharing and reporting of the VIN and associated miles reporting requirements in order to receive emissions credits reimbursement. The customer receives a document that details providing reporting information and legal details and conditions of sale of emissions in a step 404.A. The customer is also provided with a document detailing required registration information in a step 404.B. The customer must agree to provide data to support emissions claims such as VIN and mileage in a step 404.C. Data must be verified to ensure legitimate emissions credit available (e.g. through an EMDbase).

In a step 405, the emissions credits are sold by a third party at market price for reimbursement to registered owners. A document containing details of reimbursement to the owners of ZEV and PZEV is provided in a step 405.A. In a step 406, cash/reimbursement is sent to registered online owner of ZEV/PZEV.

If the customer declines to participate initially at step 403.A, in step 407, the customer is presented with options at end of lease to sell emissions credits still credited to the customer. In a step 408, the customer is presented with the option to accept 408.B. or decline 408.A the program. If the customer accepts 408.B, the customer proceeds to step 404, described above.

If the customer still declines the program at 408.A, in step 409, the dealership once taken ownership of vehicle and lessee did not previously sell credits (additional options may have been available for the lessee to have already sold the credits) then the dealership now has the option to receive credit for emissions. In step 410, the dealer registers online providing required information for emissions sales including sharing and reporting of the VIN and associated miles reporting requirements in order to receive emissions credits reimbursement, just like a customer. In a step 410.A, a document details providing reporting information and legal details and conditions of sale of emissions is provided to the dealer. In a step 410.B, a document detailing required registration information is also provided to the dealer. In a step 410.C, the dealer agrees to provide data to support emissions claims such as VIN and mileage. Data must be verified to ensure legitimate emissions credit available (e.g. through an EMDbase).

In a step 411, the emissions credits are sold by a third party at market price for reimbursement to registered owners, i.e. the dealer. In a step 411.A, a document containing details of reimbursement to owners (i.e. dealer) of ZEV and PZEV is provided to the dealer. In a step 412, cash/reimbursement sent to registered online owner (in this case, the dealership) of ZEV/PZEV.

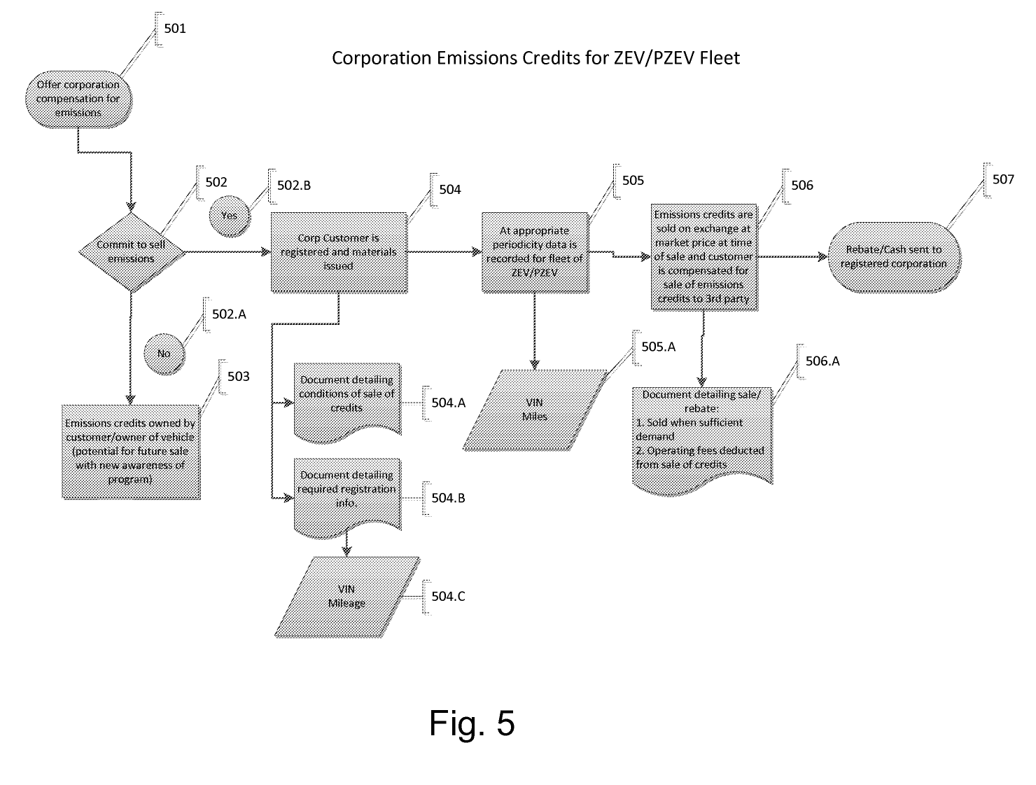

In a fifth scenario illustrated in FIG. 5, a system for corporate emissions credits for a fleet of ZEV/PZEV is show. Although the term “corporation” is used, the system may also be used for any eligible entity that maintains a fleet of eligible vehicles, such a municipality, non-profit, county government, unincorporated business, a state agency or department, etc. In a step 501, an offer of corporation compensation for their vehicle emissions is made. In step 502, the corporation must decide to accept 502.B or decline 502.A to sign up for program. In a step 503, if the corporation declines the program 502A, the corporate owner of ZEV/PZEV fleet retains the rights to the emissions credits from the vehicles and potential for future sale of emissions credits.

If the corporate customer accepts 502.B the program, in a step 504, the corporate customer is committed and registered for emissions exchange. In a step 504.A, document details providing reporting information and legal details and conditions of sale of emissions is provided to the corporate customer. In a step 504.B, document detailing required registration information is provided to the corporate customer. In a step 504.C, Data to support emissions claims such as VIN and mileage is provided by the corporate customer. Data must be verified to ensure legitimate emissions credit available (e.g. through an EMDbase).

In a step 505, at an appropriate interval/periodicity, data is recorded/confirmed for the fleet of ZEV/PZEV. In a step 505.A, Data to support emissions claims such as VIN and mileage changes and must be periodically provided by the corporate customer. Data must be verified at appropriate periodicity to ensure legitimate emissions (e.g. through an EMDbase). In a step 506, Emissions credits are sold by a third party at market price for reimbursement to registered owners/corporations. In a step 506.A, a document containing details of reimbursement to owners of ZEV and PZEV is provided to the corporate customer. In a step 507, cash/reimbursement sent to registered corporations of ZEV/PZEV.

Therefore, it can be seen that the system describes an efficient method of transferring emissions credits between parties to maximize the beneficial use of the emissions credits, and thus, maximizing the benefits to the environment and the economy.

It would be appreciated by those skilled in the art that various changes and modifications can be made to the illustrated embodiments without departing from the spirit of the present invention. All such modifications and changes are intended to be within the scope of the present invention.

What is claimed is:

1. A method of tracking and transferring carbon emissions credits for qualifying vehicles, comprising:
registering the qualifying vehicle with a verification database;
logging distance traveled over a time period of the qualifying vehicle, the qualifying vehicle having a carbon emissions rate; and
recording the distance traveled over the time period in a verification database;
calculating a carbon emissions credit based on the distance traveled, time period and the carbon emissions rate; and
transferring the carbon emissions credit to a third party.

2. The method of claim 1, wherein the step of transferring the carbon emissions credit is completed at a time of purchase of the qualifying vehicle.

3. The method of claim 1, wherein the step of transferring the carbon emissions credit is completed at a time of lease of the qualifying vehicle.

4. The method of claim 1, wherein the step of transferring the carbon emissions credit is completed during a vehicle inspection of the qualifying vehicle.

5. The method of claim 1, wherein the qualifying vehicle is a partial zero emissions vehicle.

6. The method of claim 1, wherein the qualifying vehicle is a zero emissions vehicle.

7. The method of claim 1, wherein the time period is at least monthly.

8. The method of claim 7, wherein the time period is at least weekly.

9. The method of claim 8, wherein the time period is daily.

10. The method of claim 1, wherein the step of recording the distance traveled over the time period occurs automatically by the qualifying vehicle.

11. The method of claim 1, wherein the step of recording the distance traveled over the time period occurs manually by the operator or owner of the vehicle.

12. The method of claim 1, wherein the step of recording the distance traveled over the time period occurs during a vehicle inspection.

13. The method of claim 1, wherein the step of transferring the carbon emissions credit comprises:
purchasing the qualifying vehicle by a consumer, the qualifying vehicle having an expected lifetime carbon emissions credit extrapolated from the carbon emissions rate; and
offering a rebate to the consumer, the rebate correlating to the value of the carbon emissions credit.

14. The method of claim 13, wherein the rebate is to a purchase cost of the vehicle.

15. The method of claim 1, wherein the rebate is to future maintenance costs of the qualifying vehicle.

16. The method of claim 1, wherein the step of transferring the carbon emissions credit comprises:
performing a vehicle inspection of the qualifying vehicle;
determining if the qualifying vehicle passed inspection;
offering a rebate to the consumer, the rebate correlating to the value of the carbon emissions credit earned since the previous vehicle inspection, or since time of acquisition if this is the first vehicle inspection.

17. The method of claim 16, wherein the rebate is applied to a vehicle inspection fee of the vehicle.

18. The method of claim 1, further comprising providing a document detailing the conditions of the transfer of the carbon emissions credit.

19. The method of claim 1, further comprising selling the carbon emissions credit on a carbon credit exchange.

20. The method of claim 1, further comprising:
leasing the qualifying vehicle by a consumer, the qualifying vehicle having an expected lifetime carbon emissions credit extrapolated from the carbon emissions rate; and
offering a rebate to the dealership of the qualifying vehicle if the consumer declines the carbon emissions credit, the rebate correlating to the value of the carbon emissions credit.
